(19) United States
(12) Patent Application Publication
(10) Pub. No.: US 2004/0252105 A1
(43) Pub. Date: Dec. 16, 2004

(54) BioMouse

(76) Inventors: John McCarthy, Woodland Hills, CA (US); Eileen McCarthy, Woodland Hills, CA (US)

Correspondence Address: Thomas G. Raffin, Esq., Patent SMART, PLLP., 291 South Syndicate Street, Saint Paul, MN, 55105-2812, US

(21) Appl. No.: 10/385,449

(22) Filed: Jun. 13, 2003

(51) Int. Cl. G09G 5/08

(52) U.S. Cl. 345/163

(57) ABSTRACT

A Biomouse has control a plurality of buttons at one end and a means to connect to computer at the other end. There is a hump in the middle of the BioMouse for better connection to the human palm of the hand between the base of the thumb and the center of the palm. This hump also contains a temperature monitor to transmit this temperature to the computer. The BioMouse is manufactured from a temperature sensitive plastic giving a biofeedback from the computer in a color format to the end user. Adding a heat sensitive graduated thermal strip gives numerical readout to the color indications.

### BACKGROUND OF THE INVENTION

1. Field of the Invention

The present invention relates to measurement of temperatures present in the hand while a person is using a computer mouse.

2. Description of the Prior Art

### Existing Computer Mice

Since the invention of the mouse at Xerox and the application in Apple computers, IBM personal computers and workstations the mouse has become a primary source of control and input for computers. The mouse functions by gliding across a surface for short distances while on the computer screen, the user moves a corresponding visible pointer on the computer screen. Button clicks are used to indicate choices made or moving a cursor to a location on a page by clicking on a control bar, clicking yes no buttons in a so called radio dial or moving a cursor to a location on a page or form where text is entered. The mouse has been utilized with very frequent button pressing repetitions, particularly when viewing interactive materials such as are seen on websites through the World Wide Web on the Internet. Mice are available in a variety of designs that have one, two, or three buttons with which the user indicates choice by clicking a button on the mouse.

The repetitive button pressing has become the source of a so-called RSI (repetitive strain injury) that causes pain in the forearm and hand via irritation of the tendons within the carpal tunnel of the wrist. Several users have suggested that resting the side of the hand opposite the thumb on the table or surface upon which the mouse glides is a neutral position that allows movement of the mouse with less bending of the wrist. If that neutral position can be maintained some persons (Kingsway Innovations Patent Pending) have suggested that RSI can be significantly reduced. Temperature indication would help the users to know that their hand and muscles are being stressed.

### BACKGROUND OF THE PRESENT INVENTION

Computer mice are input output devices seen with almost every computer and data terminal today. For purposes of studying biofeedback it would be useful to have an electrode built into the mouse. No previous mouse has heat sensitive plastic on the surface of the mouse where the palm of the hand touches the mouse.

### SUMMARY OF THE PRESENT INVENTION

A primary object of the invention is to provide the BioMouse with control buttons at one end and a cover of heat sensitive plastic over the entire surface of the BioMouse. Another object of the invention is to provide a bilaterally symmetrical mouse that can be used by right handed and left handed individuals. A third objective of the invention is to transmit the temperature of a person's hand to the computer for use in background screen coloration.

### BRIEF DESCRIPTION OF THE DRAWINGS

FIG. 1 is a perspective view of the BioMouse.

### DETAILED DESCRIPTION OF THE PREFERRED EMBODIMENTS OF THE PRESENT INVENTION

The detailed embodiments of the present invention are disclosed herein, however, it is to be understood that the disclosed embodiments are exemplary of the invention, which may be embodied in various forms. The details disclosed herein are not to be interpreted as limited, but merely as the basis for the claims and as a basis for teaching one skilled in the art how to make and/or use the invention.

The covering of the mouse shall be composed of Liquid crystals. Liquid crystals are a natural organic chemical which exhibits special properties when subjected to changes in temperature; its molecular helical structure expands and contracts, reflecting bright color changes visible to the eye. Thermochromic Liquid Crystals (LCs) are materials that change their molecular structure and optical properties with temperature. In its active state, LC's first show a milky brown, then red, yellow, green, blue, violet, and then black again above the temperature range. A bright green color is most dominant when a liquid crystal formulation is “on”, and is usually used as the point of temperature measurement of each particular formulation.

LC's are specified by their color play; the Red Start temperature and a bandwidth. The bandwidth is the difference between the Red Start and Blue Start temperatures. A liquid crystal specified as R28C5W would indicate is had a Red Start of 28 degrees Celsius and a bandwidth that is 5 degrees Celsius wide to give it a Blue Start of 33 degrees Celsius. The Green Start temperature is about halfway between the red and blue start temperatures.

A temperature element such as a thermocouple or RTD would be mounted in the hump area of the mouse for transmission of hand temperature to the associated computer.

This mouse shell can be manufactured by pouring or spraying the liquid crystals into the form of a mouse, and then the electro-mechanical internals of the mouse can be added.

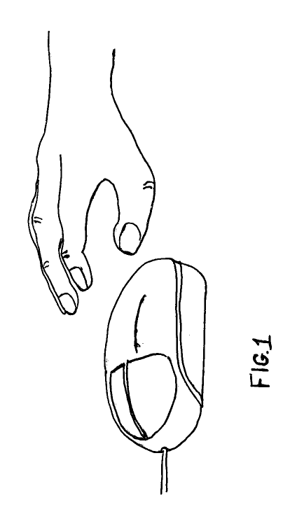

FIG. 1 shows a first embodiment of the invention with a hand in shadow covering the rear of the mouse.

We claim:

1. A BioMouse comprising:
a body base, a first end, a second end and two symmetrical sidewalls that rise vertically and meet centrally in an elongated bilaterally symmetrical hump with a covering of Liquid crystals overall, a means for connection to a computer at first end and a plurality of mouse buttons located near the mouse base at said first end.
